(19) United States
(12) Patent Application Publication
(10) Pub. No.: US 2026/0028238 A1
(43) Pub. Date: Jan. 29, 2026

(54) SOLID ALUMINA COMPOSITION AND METHODS OF MAKING AND USING THEREOF

(71) Applicant: Braskem America, Inc., Philadelphia, PA (US)

(72) Inventor: Dan Xie, Pittsburgh, PA (US)

(21) Appl. No.: 19/282,655

(22) Filed: Jul. 28, 2025

Related U.S. Application Data
(60) Provisional application No. 63/676,590, filed on Jul. 29, 2024.

(51) Int. Cl. C01F 7/021; B01J 21/04; B01J 37/04; B01J 37/08

(52) U.S. Cl. CPC C01F 7/021; B01J 21/04; B01J 37/04; B01J 37/08; C01P 2002/72; C01P 2006/80

(57) ABSTRACT

A solid alumina composition is prepared from an acid-treated precursor composition, the precursor composition having an alumina hydroxide (Al(OH)₃), aluminum oxyhydroxide (AlO(OH)), or a mixture thereof; where the solid alumina composition includes η-alumina characterized by having an X-ray powder diffraction pattern with peaks at 19.6±0.5° 2θ and 66.8±0.5° 2θ; and where the solid alumina composition has an acidity measured by an NH₃-TPD test, characterized by: (1) an acid site density ranging from about 200 to 800 μmol/g; and/or (2) an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%).

### PRIORITY CLAIM

This application claims priority under 35 U.S.C. § 119 (e) to U.S. Provisional Application No. 63/676,950, filed Jul. 29, 2025, herein incorporated by reference in its entirety.

### BACKGROUND OF THE INVENTION

Expanding a portfolio of biobased chemical production pathways is a key strategy in the polyolefin industry, to achieve sustainability goals set by the industry. From a technology perspective, developing robust catalyst systems that could either produce targeted biobased chemicals and improve their yields, or promote better energy efficiency to reduce carbon emissions in chemical processes, is an important competitive advantage. A goal therefore is to develop catalysts and catalyst systems with increased performance in dehydration pathways of alcohols and polyols, strengthening a technology portfolio in the field of biomass conversion to industrially important chemicals.

The present invention relates in part at least to a novel catalytic material and a method of making the same. The novel catalytic material can be a solid acid material that can be used for a variety of catalytic applications. Examples include renewable chemical conversions, and petrochemical productions using novel routes to reduced carbon footprint. The novel catalyst material can be an eta-alumina-based material, and compared to commercially available alumina catalysts, either in gamma (γ-) form or in eta form (η-), the novel catalyst material of the present invention offers higher acid site concentration and optimal distribution of acid site strength, and therefore is more active than commercially available alumina catalysts.

### BRIEF SUMMARY OF THE INVENTION

An embodiment of the present invention relates to a solid alumina composition prepared from an acid-treated precursor composition, said precursor composition comprising an alumina hydroxide (Al(OH)₃₎, aluminum oxyhydroxide (AlO(OH)), or a mixture thereof; wherein the solid alumina composition comprises η-alumina characterized by having an X-ray powder diffraction pattern comprising the peaks at 19.6±0.5° 2θ and 66.8±0.5° 2θ; and wherein the solid alumina composition has an acidity measured by an NH₃-TPD test, characterized by: (1) an acid site density ranging from about 200 to 800 μmol/g (such as from about 250 to about 800, from about 300 to about 800, or from about 400 to about 800 μmol/g); and/or (2) an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%).

Another embodiment of the present invention relates to a solid alumina composition above, which comprises η-alumina at a high purity, characterized by a ratio of a peak intensity at 19.6±0.5° 2θ, relative to a peak intensity at 66.8±0.5° 2θ, being about 3% or greater, preferably from about 3% to about 10%, or preferably from about 6% to about 10%.

Another embodiment of the present invention relates to a solid alumina composition above, which has an acidity measured by an NH₃-TPD test, characterized by: (1) an acid site density ranging from about 200 to 800 μmol.

Another embodiment of the present invention relates to a solid alumina composition above, which has an acidity measured by an NH₃-TPD test, characterized by: (2) an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%).

Another embodiment of the present invention relates to a solid alumina composition above, which comprises an acidity measured by an NH₃-TPD test, characterized by: (1) an acid site density ranging from about 250 to about 800, preferably from about 300 to about 800, or preferably from about 400 to about 800 μmol/g.

Another embodiment of the present invention relates to a solid alumina composition above, wherein the aluminum hydroxide comprises bayerite.

Another embodiment of the present invention relates to a solid alumina composition above, wherein the aluminum oxyhydroxide comprises boehmite (γ-AlO(OH)), pseudo-boehmite (e.g., finely crystalline boehmite), or a mixture thereof.

Another embodiment of the present invention relates to a solid alumina composition above, wherein the precursor composition comprises a mixture of bayerite and boehmite or pseudo-boehmite, optionally containing over 50 wt % (such as over 60 wt %, over 70 wt %, over 80 wt %, over 90 wt %, or over 95 wt %) bayerite.

Another embodiment of the present invention relates to a solid alumina composition above, wherein an acid to obtain the acid-treated precursor composition, comprises an acid selected from the group consisting of an inorganic acid, a halogen acid, an organic acid, and a mixture thereof.

Another embodiment of the present invention relates to a solid alumina composition above, wherein the acid comprises an inorganic acid selected from the group consisting of sulfuric acid, boric acid, nitric acid, and a mixture thereof.

Another embodiment of the present invention relates to a solid alumina composition above, wherein the acid comprises a halogen acid selected from the group consisting of hydrochloric acid, hydrobromic acid, and a mixture thereof.

Another embodiment of the present invention relates to a solid alumina composition above, wherein the acid comprises an organic acid selected from the group consisting of acetic acid, citric acid, malic acid, tartaric acid, propionic acid, butyric acid, valeric acid, lactic acid, hydracrylic acid, glyceric acid, levulinic acid, malonic acid, glutaric acid, succinic acid, pimelic acid, and a mixture thereof.

Another embodiment of the present invention relates to a solid alumina composition above, wherein the acid comprises an acid selected from the group consisting of nitric acid, acetic acid, citric acid, malic acid, tartaric acid, or a mixture thereof.

Another embodiment of the present invention relates to a process for preparing a solid alumina composition, the process comprising: treating a precursor composition comprising an alumina hydroxide (Al(OH)₃), aluminum oxyhydroxide (AlO(OH)), or a mixture thereof with an acid, to form an acid-treated precursor composition; dispersing the acid-treated precursor composition into a homogenous aqueous suspension of particles; drying the homogenous aqueous suspension of particles; and calcinating the dried particles, to form a solid alumina composition.

Another embodiment of the present invention relates to a process above, wherein the dispersing is carried out by sonication, stirring, shaking, or a combination thereof.

Another embodiment of the present invention relates to a process above, wherein adding a surfactant to the homogenous aqueous suspension of particles.

Another embodiment of the present invention relates to a process above, wherein the surfactant comprises a cationic surfactant, an anionic surfactant, or a combination thereof.

Another embodiment of the present invention relates to a process above, wherein the cationic surfactant comprises a salt of a quaternary ammonium cation selected from the group consisting of cetyltrimethylammonium, cetylpyridinium, polydially dimethyl ammonium, and a combination thereof, and wherein the anionic surfactant comprises a surfactant selected from the group consisting of an alkyl sulfate, an alkyl-ether sulfate, an alkylbenzene sulfonate, a perfluoroalkanesulfonate, an alkyl-aryl ether phosphate, an alkyl ether phosphate, sodium stearate, and a combination thereof.

Another embodiment of the present invention relates to a process above, wherein the non-ionic surfactant comprises at least one member selected from the group consisting of a fatty alcohol ethoxylate, an alkyl phenol ethoxylate, a fatty acid alkoxylate, an ethylene oxide/propylene oxide copolymer, and a poly(ethylene oxide)-based surfactant.

Another embodiment of the present invention relates to a process above, wherein the poly(ethylene oxide)-based surfactant comprises at least one of TERGITOL 15-S-5, TERGITOL 15-S-7, TERGITOL 15-S-9, and TERGITOL 15-S-12.

Another embodiment of the present invention relates to a process above, wherein the surfactant comprises cetyltrimethylammonium bromide, poly-diallyldimethylammonium chloride, or Tergitol 15-S-7.

Another embodiment of the present invention relates to a process above, wherein the drying is carried out at a temperature ranging from about 20° C. to about 200° C., preferably from about 50° C. to about 150° C., or preferably from about 90° C. to about 100° C.

Another embodiment of the present invention relates to a process above, further comprising, prior to calcinating: cooling the dried particles to an ambient temperature.

Another embodiment of the present invention relates to a process above, wherein the calcinating is carried out at a temperature ranging from about 400° C. to about 750° C., preferably from about 500° C. to about 650° C.

Another embodiment of the present invention relates to a process above, wherein the calcinating is carried out at a ramp rate of about 0.5° C./minute to about 2° C./minute (such as about 1° C./minute), from ambient temperature to reach a final temperature of from about 500° C. to about 650° C. (such as from about 600° C. to about 650° C.), and optionally maintaining at the final temperature for about 4-12 hours (e.g., about 6-10 hours, about 8-10 hours, or about 10 hours).

Another embodiment of the present invention relates to a process above, wherein the calcinating is carried out in a stepwise manner, comprising: a first calcinating from ambient temperature to a reach a first temperature ranging from about 400° C. to about 450° C. (such as about 400° C.), and maintaining at the first temperature for about 1-3 hours (e.g., about 2 hours); a second calcinating from the first temperature to a second temperature ranging from about 450° C. to about 550° C. (such as about 500° C.), and maintaining at the second temperature for about 1-3 hours (e.g., about 2 hours); and a third calcinating from the second temperature to the final temperature, and maintaining at the final temperature for about 4-8 hours (e.g., about 6 hours).

Another embodiment of the present invention relates to a solid alumina composition prepared according to any process herein, wherein the solid alumina composition comprises n-alumina characterized by having an X-ray power diffraction pattern comprising the peaks at 19.6.0±0.5 and 66.8±0.5° 2θ.

Another embodiment of the present invention relates to a solid alumina composition above, wherein the solid alumina composition is an acid type, optionally having an acidity measured by a NH₃-TPD test characterized by: (1) an acid site density ranging from about 200 to 800 μmol/g (such as from about 250 to about 800, from about 300 to about 800, or from about 400 to about 800 μmol/g); and/or (2) an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%).

Another embodiment of the present invention relates to a solid alumina composition above, wherein the solid alumina composition comprises η-alumina at a high purity, characterized by the ratio of the peak intensity at 20.0 (±0.2)° 2θ relative to the peak intensity at 67.0 (±0.2)° 2θ being about 3% or greater (such as ranging from about 3% to about 10%, or from about 6% to about 10%).

### BRIEF DESCRIPTION OF SEVERAL VIEWS OF THE DRAWING

FIG. 1 shows a XRPD patterns for γ-alumina and η-alumina.

### DETAILED DESCRIPTION OF THE INVENTION

The indefinite articles “a” and “an” generally mean “at least one” in the sense of “a” or “an”. The indefinite article “a” can also mean “any.” Those skilled in the art will understand that the indefinite article “a” does not necessarily mean the indefinite article “a” but rather the indefinite article “a” in the sense of “1”, and that in one embodiment the indefinite article “a” also includes the indefinite article “a” (1). Furthermore, the indefinite article can mean “one” or “at least one.”

### a Solid Alumina Composition

An embodiment of the present invention relates to a solid alumina composition prepared from an acid-treated precursor composition. The precursor composition comprises, consists of, or has, an alumina hydroxide (Al(OH)₃), aluminum oxyhydroxide (AlO(OH)), or a mixture thereof. The mixture can be any two or all of these components. The solid alumina composition can comprise, or consist of, η-alumina characterized by having an X-ray powder diffraction pattern comprising peaks at 19.6±0.5° 2θ and 66.8±0.5° 2θ.

The solid alumina composition can comprise, or have, an acidity measured by an NH₃-TPD test, characterized by: (1) an acid site density ranging from about 200 to 800 μmol/g (such as from about 250 to about 800, from about 300 to about 800, or from about 400 to about 800 μmol/g); and/or (2) an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%). The NH₃-TPD is described below, under

### Characterization Tests

A solid alumina composition herein can comprise or have an acidity measured by an NH₃-TPD test, characterized by: (1) an acid site density ranging from about 200 to 800 μmol. The density can range from about 250 to about 800, or from about 300 to about 800, or from about 400 to about 800 μmol/g. All values between these minima and maxima are included in this description.

A solid alumina composition herein can comprise or have an acidity measured by an NH₃-TPD test, characterized by: (2) an acid strength distribution of: about 20%-70% weak acid sites, about 30%-80% medium acid sites, and about 0-20% strong acid sites. Regarding the weak acid sites, preferably, the range can be about 30-50%, or about 30-40%, or about 35-40%, relative to all acid sites in the solid alumina composition. All values between these minima and maxima are included in this description. Regarding the medium acid sites, preferably, the range can be about 50-70%, or about 60-70%, or about 60-65%), relative to all acid sites in the solid alumina composition. All values between these minima and maxima are included in this description. Regarding the strong acid sites, preferably, the range can be about 0-10%, or about 0-5%, or about 0-2%, relative to all acid sites in the solid alumina composition.

In an embodiment of a solid alumina composition herein, the solid alumina composition can comprise, or consist of, a η-alumina at a high purity. The high purity can be characterized by a ratio of a peak intensity at 19.6±0.5° 2θ, relative to a peak intensity at 66.8±0.5° 2θ, of the n-alumina, being about 3% or greater. Preferably, this ratio can be from about 3% to about 10%, or preferably from about 6% to about 10%. All values between these minima and maxima are included in this description.

In an embodiment, the aluminum hydroxide of the solid alumina composition, can comprise, or consist of, bayerite. Alternatively, or in addition to bayerite, the aluminum oxyhydroxide can comprise, or consist of, boehmite (γ-AlO(OH)), pseudo-boehmite (e.g., finely crystalline boehmite), or a mixture thereof.

In an embodiment, the precursor composition can comprise, or consist of, a mixture of bayerite and boehmite or pseudo-boehmite, optionally containing over 50 wt %, preferably over 60 wt %, or over 70 wt %, or over 80 wt %, or over 90 wt %, or over 95 wt %, bayerite. All values between these minima and maxima are included in this description.

In an embodiment, the acid-treated precursor composition can be obtained by treating a precursor composition discussed herein with an acid. In embodiments, the acid can comprise, or consist of, an acid selected from the group consisting of an inorganic acid, a halogen acid, an organic acid, and a mixture thereof. In embodiments, the acid comprises an inorganic acid selected from the group consisting of sulfuric acid, boric acid, nitric acid, and a mixture thereof. In embodiments, the acid comprises a halogen acid selected from the group consisting of hydrochloric acid, hydrobromic acid, and a mixture thereof. These acids can be by themselves or in a mixture of any other acid listed herein.

In an embodiment of a solid alumina composition herein, the acid can comprise, or consist of, an organic acid selected from the group consisting of acetic acid, citric acid, malic acid, tartaric acid, propionic acid, butyric acid, valeric acid, lactic acid, hydracrylic acid, glyceric acid, levulinic acid, malonic acid, glutaric acid, succinic acid, pimelic acid, and a mixture thereof. These acids can be by themselves or in a mixture of any other acid listed herein.

In an embodiment of a solid alumina composition herein, the acid can comprise, or consist of, an acid selected from the group consisting of nitric acid, acetic acid, citric acid, malic acid, tartaric acid, or a mixture thereof. These acids can be by themselves or in a mixture of any other acid listed herein.

### Process for Preparing a Solid Alumina Composition

Another embodiment of the present invention relates to a process for preparing a solid alumina composition, the process comprising: treating a precursor composition comprising an alumina hydroxide (Al(OH)₃), aluminum oxyhydroxide (AlO(OH)), or a mixture thereof with an acid, to form an acid-treated precursor composition; dispersing the acid-treated precursor composition into a homogenous aqueous suspension of particles; drying the homogenous aqueous suspension of particles; and calcinating the dried particles, to form a solid alumina composition.

In an embodiment of a process of preparing a solid alumina composition herein, the dispersing can be, or is, carried out by sonication, stirring, shaking, or a combination thereof.

In an embodiment of a process of preparing a solid alumina composition herein, the process can further comprise adding a surfactant to the homogenous aqueous suspension of particles. In embodiments, the surfactant can comprise, or consist of, a cationic surfactant, an anionic surfactant, or a combination thereof. In other embodiments, separate from or in addition to the cationic surfactant and/or anionic surfactant, the surfactant can comprise, or consist of, a non-ionic surfactant.

The cationic surfactant can comprise, or consist of, a salt of a quaternary ammonium cation selected from the group consisting of cetyltrimethylammonium, cetylpyridinium, polydially dimethyl ammonium, and a combination thereof. The anionic surfactant can comprise, or consist of, a surfactant selected from the group consisting of an alkyl sulfate, an alkyl-ether sulfate, an alkylbenzene sulfonate, a perfluoroalkanesulfonate, an alkyl-aryl ether phosphate, an alkyl ether phosphate, sodium stearate, and a combination thereof. The non-ionic surfactant can comprise, or consist of, at least one member selected from the group consisting of a fatty alcohol ethoxylate, an alkyl phenol ethoxylate, a fatty acid alkoxylate, an ethylene oxide/propylene oxide copolymer, and a poly(ethylene oxide)-based surfactant.

In embodiments, the poly(ethylene oxide)-based surfactant can comprise, or consist of, at least one of TERGITOL 15-S-5, TERGITOL 15-S-7, TERGITOL 15-S-9, and TERGITOL 15-S-12. In embodiments, the surfactant can comprise, or consist of, cetyltrimethylammonium bromide, poly-diallyldimethylammonium chloride, or TERGITOL 15-S-7.

In embodiments, the drying is carried out at a temperature ranging from about 20° C. to about 200° C., preferably from about 50° C. to about 150° C., or preferably from about 90° C. to about 100° C. In embodiments, the process can further comprise, prior to calcinating: cooling the dried particles to an ambient temperature.

In embodiments, the calcinating is carried out at a temperature ranging from about 400° C. to about 750° C., preferably from about 500° C. to about 650° C. The calcinating can be carried out at a ramp rate of about 0.5° C./minute to about 2° C./minute (such as about 1° C./minute), from ambient temperature to reach a final temperature of from about 500° C. to about 650° C. (such as from about 600° C. to about 650° C.), and optionally maintaining at the final temperature for about 4-12 hours (e.g., about 6-10 hours, about 8-10 hours, or about 10 hours).

In embodiments, the calcinating is carried out in a stepwise manner, that can comprise: a first calcinating from ambient temperature to a reach a first temperature ranging from about 400° C. to about 450° C. (such as about 400° C.), and maintaining at the first temperature for about 1-3 hours (e.g., about 2 hours); a second calcinating from the first temperature to a second temperature ranging from about 450° C. to about 550° C. (such as about 500° C.), and maintaining at the second temperature for about 1-3 hours (e.g., about 2 hours); and a third calcinating from the second temperature to the final temperature, and maintaining at the final temperature for about 4-8 hours (e.g., about 6 hours).

### Solid Alumina Composition Made by a Process

Another embodiment of the present invention relates to a solid alumina composition prepared according to any process herein, wherein the solid alumina composition comprises n-alumina characterized by having an X-ray power diffraction pattern comprising the peaks at 19.6.0±0.5 and 66.8±0.5° 2θ. The solid alumina composition can be an acid type, optionally having an acidity measured by a NH₃-TPD test characterized by: (1) an acid site density ranging from about 200 to 800 μmol/g (such as from about 250 to about 800, from about 300 to about 800, or from about 400 to about 800 μmol/g); and/or (2) an acid strength distribution of: about 20%-70% weak acid sites (such as about 30-50%, about 30-40%, or about 35-40%), about 30%-80% medium acid sites (such as about 50-70%, about 60-70%, or about 60-65%), and about 0-20% strong acid sites (such as about 0-10%, about 0-5%, or about 0-2%).

In another embodiment, in the solid alumina composition herein, the solid alumina composition can comprise η-alumina at a high purity, characterized by the ratio of the peak intensity at 20.0 (±0.2)° 2θ relative to the peak intensity at 67.0 (±0.2)° 2θ being about 3% or greater (such as ranging from about 3% to about 10%, or from about 6% to about 10%).

### Characterization Tests

NH₃-TPD test: The acidity (i.e. acid sites) of the solid alumina composition was characterized by ammonia temperature programmed desorption (NH₃-TPD) test, using AutoChem II instrument. The produced solid alumina composition was pretreated with 10 ccm Ar at 400° C. for 2 hours, and the sample was exposed to the flow of NH₃ in Ar for 1 hour at 50° C. After NH₃ exposure, the sample was purged under the flow of Ar for 1 hour to removed weakly adsorbed NH₃, followed by heating under the flow of Ar (10 ccm Ar) to 625° C. at 10° C./min.

The NH₃-TPD profile was measured using a mass spectrometer, to quantify the sample acid site concentration. The “weak” acid sites were defined as the acid sites having a desorption temperature lower than 200° C.; the “medium” acid sites were defined as the acid sites having a desorption temperature range from 200 to 450° C., and the “strong” acid sites were defined as the acid sites having a desorption temperature higher than 450° C. A detailed discussion of the NH₃-TPD experiment and procedure can be found in: J. L. Falconer, J. A. Schwarz, Temperature-programmed desorption and reaction: applications to supported catalysts, Catal. Rev. 25 (June 2) (1983) 141-227.

X-ray Powder Diffraction (XRPD): XRPD patterns were collected on a diffractometer (such as a PANalytical X′Pert PRO or equivalent) using an incident beam of Cu Kα radiation (45 kV, 40 mA), θ-θ goniometer, focusing mirror, divergence slit (½″), soller slits at both incident and divergent beam (4 mm) under ambient conditions. The data collection range was 3-35° 2θ with a continuous scan speed of 0.2° s⁻¹.

The term “peak” refers to a signal that represents a reflection in the x-ray powder diffraction pattern. The peaks characterizing η-alumina in the x-ray powder diffraction pattern should be clear and distinct with low or minimum background noise.

### EXAMPLES

### Example 1

5.2 g of Bayerite hydroxide powder (PURAL BT from Sasol) was added to 50 mL of a 0.4M nitric acid solution under vigorous stirring. The suspension was sonicated for at least 10 minutes to achieve a homogeneous dispersion of the aluminum hydroxide particles. Then, 0.2 g of a 20 wt % poly-diallyldimethylammonium chloride solution was added to the gel under vigorous stirring. The mixture was then dried in open container at 95° C. for 34 hours and cooled down to room temperature. The final alumina product, BCM-1, was obtained by further calcining the dried powder sample under air flow from room temperature to 400° C. with a ramp rate of 1° C./minute and kept for 2 hours, then to 500° C. with the same ramp rate and kept for 2 hours, and to 600° C. with the same ramp rate and kept for 6 hours.

Acid site measurements according to the NH3-TPD Characterization Tests described herein were performed on BCM-1. The results are shown in Table 1.

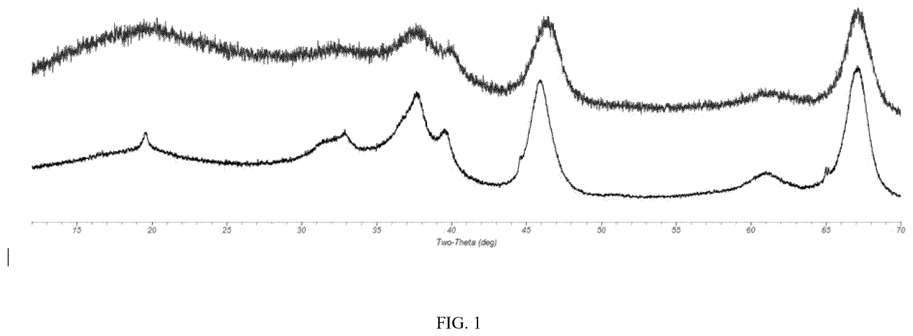

FIG. 1 shows XRPD patterns for γ-alumina and η-alumina of BCM-1. The top pattern is for the γ-alumina fraction of BCM-1, and the bottom pattern is for the η-alumina fraction of BCM-1. The XRPD patterns for BCM-1 were obtained via the X-ray Powder Diffraction method of the Characterization Tests described herein.

### Example 2

7.8 g of Bayerite hydroxide powder (PURAL BT from Sasol) was added to 80 g of deionized water and 10 mL of a 0.1M nitric acid solution under vigorous stirring. Then, 19.21 g of citric acid was slowly added to the solution under vigorous stirring at 80° C. The gel was stirred for at least 2 hours to ensure a homogeneous dispersion of the aluminum hydroxide particles, before 2.6 g of TERGITOL 15-S-7 was added. The mixture was then dried in open container at 95° C. for 60 hours and cooled down to room temperature. The final alumina product was obtained by further calcining the dried powder sample under air flow from room temperature to 400° C. with a ramp rate of 1° C./minute and kept for 2 hours, then to 500° C. with the same ramp rate and kept for 2 hours, and to 600° C. with the same ramp rate and kept for 6 hours.

### Example 3

6.0 g of Bayerite hydroxide powder (PURAL BT from Sasol) was added to 60 mL of a 0.2M nitric acid solution under vigorous stirring. The suspension was sonicated for at least 10 minutes to achieve a homogeneous dispersion of the aluminum hydroxide particles. Then, 0.6 g of a 20 wt % poly-diallyldimethylammonium chloride solution was added to the gel under vigorous stirring. The mixture was then dried in open container at 95° C. for 48 hours and cooled down to room temperature. The dried sample was further calcined under air flow from room temperature to 650° C. with a ramp rate of 1° C./minute and kept for 10 hours to obtain a final alumina product.

TABLE 1

| | Weak | Medium | Strong |
|---|---|---|---|
| | acid | acid | acid |
| Catalyst | sites | sites | sties |
| BCM-1 from Example 1 | 157 | 250 | 0 |
| Comparative γ-alumina | 137 | 46 | 11 |
| (CatalOX Sba-200 from | | | |
| Sasol) | | | |

1. A solid alumina composition prepared from an acid-treated precursor composition, said precursor composition comprising an alumina hydroxide (Al(OH)₃), aluminum oxyhydroxide (AlO(OH)), or a mixture thereof;
wherein the solid alumina composition comprises η-alumina characterized by having an X-ray powder diffraction pattern comprising the peaks at 19.6±0.5° 2θ and 66.8±0.5° 2θ; and
wherein the solid alumina composition has an acidity measured by an NH₃-TPD test, characterized by:
(1) an acid site density ranging from about 200 to 800 μmol/g; and/or
(2) an acid strength distribution of:
about 20%-70% weak acid sites,
about 30%-80% medium acid sites, and
about 0-20% strong acid sites.

2. The solid alumina composition of claim 1, which comprises η-alumina at a high purity, characterized by a ratio of a peak intensity at 19.6±0.5° 2θ, relative to a peak intensity at 66.8±0.5° 2θ, being about 3% or greater.

3. The solid alumina composition of claim 1, which has an acidity measured by an NH₃-TPD test, characterized by:
(1) an acid site density ranging from about 200 to 800 μmol.

4. The solid alumina composition of claim 1, which has an acidity measured by an NH₃-TPD test, characterized by:
(2) an acid strength distribution of:
about 20%-70% weak acid sites,
about 30%-80% medium acid sites, and
about 0-20% strong acid sites.

5. The solid alumina composition of claim 1, which comprises an acidity measured by an NH₃-TPD test, characterized by:
(1) an acid site density ranging from about 250 to about 800.

6. The solid alumina composition of claim 1, wherein the aluminum hydroxide comprises bayerite.

7. The solid alumina composition of claim 1, wherein the aluminum oxyhydroxide comprises boehmite (γ-AlO(OH)), pseudo-boehmite (e.g., finely crystalline boehmite), or a mixture thereof.

8. The solid alumina composition of claim 1, wherein the precursor composition comprises a mixture of bayerite and boehmite or pseudo-boehmite.

9. The solid alumina composition of claim 1, wherein an acid to obtain the acid-treated precursor composition, comprises an acid selected from the group consisting of an inorganic acid, a halogen acid, an organic acid, and a mixture thereof.

10. The solid alumina composition of claim 9, wherein the acid comprises an inorganic acid selected from the group consisting of sulfuric acid, boric acid, nitric acid, and a mixture thereof.

11. The solid alumina composition of claim 9, wherein the acid comprises a halogen acid selected from the group consisting of hydrochloric acid, hydrobromic acid, and a mixture thereof.

12. The solid alumina composition of claim 9, wherein the acid comprises an organic acid selected from the group consisting of acetic acid, citric acid, malic acid, tartaric acid, propionic acid, butyric acid, valeric acid, lactic acid, hydracrylic acid, glyceric acid, levulinic acid, malonic acid, glutaric acid, succinic acid, pimelic acid, and a mixture thereof.

13. The solid alumina composition of claim 9, wherein the acid comprises an acid selected from the group consisting of nitric acid, acetic acid, citric acid, malic acid, tartaric acid, or a mixture thereof.

14. A process for preparing a solid alumina composition, the process comprising:
treating a precursor composition comprising an alumina hydroxide (Al(OH)₃₎, aluminum oxyhydroxide (AlO(OH)), or a mixture thereof with an acid, to form an acid-treated precursor composition;
dispersing the acid-treated precursor composition into a homogenous aqueous suspension of particles;
drying the homogenous aqueous suspension of particles; and
calcinating the dried particles, to form a solid alumina composition.

15-26. (canceled)

27. A solid alumina composition prepared according to the process of claim 14, wherein the solid alumina composition comprises η-alumina characterized by having an X-ray power diffraction pattern comprising the peaks at 19.6.0±0.5 and 66.8±0.5° 2θ.

28-29. (canceled)

30. The solid alumina composition of claim 8, wherein the precursor composition comprises over 50 wt % bayerite.
